(19) United States
(12) Patent Application Publication
(10) Pub. No.: US 2026/0230150 A1
(43) Pub. Date: Aug. 6, 2026

(54) FEATURE VECTOR COMPRESSION FOR TWO-SIDED CHANNEL STATE INFORMATION FEEDBACK MODELS IN WIRELESS NETWORKS

(71) Applicant: Lenovo (Singapore) Pte. Limited, Singapore (SG)

(72) Inventors: Venkata Srinivas Kothapalli, Aurora, IL (US); Vahid Pourahmadi, München (DE); Ahmed Hindy, Aurora, IL (US); Vijay Nangia, Woodridge, IL (US)

(73) Assignee: Lenovo (Singapore) Pte. Limited, Singapore (SG)

(21) Appl. No.: 19/149,755

(22) PCT Filed: Jan. 19, 2024
(86) PCT No.: PCT/IB2024/050541

§ 371 Date: Jul. 21, 2025

Related U.S. Application Data
(60) Provisional application No. 63/440,537, filed on Jan. 23, 2023.
(60) Provisional application No. 63/483,178, filed on Feb. 3, 2023.

(51) Int. Cl. H04B 7/06; H04B 7/0456; H04B 17/391; H04L 5/00; H04W 24/10

(52) U.S. Cl. CPC H04B 7/0663; H04B 7/0486; H04B 17/3912; H04L 5/0048; H04W 24/10

(57) ABSTRACT

Various aspects of the present disclosure relate to feature vector compression for two-sided channel state information feedback models in wireless networks. A receiving device receives pilot or reference signals from a transmitting device on a wireless channel and generates channel state information (CSI) feedback for the wireless channel. The receiving device uses an encoder neural network to generate a feature vector based on the CSI feedback. The receiving device also factorizes, based on Khatri-Rao factorization, the feature vector into one or more components with each component including a first factor vector and a second factor vector, and each of the first factor vector and the second factor vector has fewer elements than the feature vector. The receiving device transmits the first factor vector and the second factor vector to the transmitting device, which can reconstruct the CSI feedback from the first factor vector and the second factor vector.

### RELATED APPLICATION

This application claims priority to U.S. Patent Application Ser. No. 63/483,178 filed Feb. 3, 2023 entitled “FEATURE VECTOR COMPRESSION FOR TWO-SIDED CHANNEL STATE INFORMATION FEEDBACK MODELS IN WIRELESS NETWORKS,” the disclosure of which is incorporated by reference herein in its entirety. This application also claims priority to U.S. Patent Application Ser. No. 63/440,537 filed Jan. 23, 2023 entitled “LOW-RANK COMPRESSION OF CHANNEL STATE INFORMATION IN WIRELESS NETWORKS,” the disclosure of which is incorporated by reference herein in its entirety.

### TECHNICAL FIELD

The present disclosure relates to wireless communications, and more specifically to feature vector compression for two-sided artificial intelligence (AI)/machine learning (ML) models used for channel state information (CSI).

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In the wireless communications system, CSI feedback can be transmitted from one device to another, such as from a UE to a base station (e.g., a gNB) or from a base station (e.g., a gNB) to a UE. The CSI feedback provides the receiving device with an indication of the quality of a channel at a particular time.

### SUMMARY

The present disclosure relates to methods, apparatuses, and systems that support feature vector compression for two-sided channel state information feedback models in wireless networks. A receiving device receives pilot or reference signals from a transmitting device on a wireless channel and generates CSI feedback for the wireless channel. The receiving device uses an encoder neural network (NN) to generate a feature vector based on the CSI feedback. The receiving device also factorizes, based on Khatri-Rao (KR) factorization, the feature vector into one or more components with each component including a first factor vector and a second factor vector, and each of the first factor vector and the second factor vector has fewer elements than the feature vector. The receiving device transmits the first factor vector and the second factor vector to the transmitting device, and the transmitting device can reconstruct the feature vector from the first factor vector and the second factor vector, and reconstruct the CSI feedback from the feature vector. By factoring the feature vector, CSI signaling overhead is reduced due to the first factor vector and the second factor vector together being smaller than the feature vector.

Some implementations of the method and apparatuses described herein may further include to: determine at least one feature vector of input data; factorize, based on Khatri-Rao factorization, the at least one feature vector into one or more components wherein each component comprises a first factor vector and a second factor vector, and each of the first factor vector and the second factor vector has fewer elements than the feature vector; generate encoded information by encoding at least the first factor vector or the second factor vector in at least one of the components; transmit, to a first device, a first signaling indicating the encoded information.

In some implementations of the method and apparatuses described herein, the first factor vector is a first column vector, the second factor vector is a second column vector, and the feature vector is a column vector. Additionally or alternatively, the input data is channel state information. Additionally or alternatively, the method and apparatuses are to: receive, from the first device, at least one reference signal; and generate the channel state information based on the received at least one reference signal. Additionally or alternatively, the channel state information comprises a characterization of a channel matrix or a channel covariance matrix. Additionally or alternatively, the at least one feature vector of the input data is based at least in part on a first set of information of an encoder neural network model. Additionally or alternatively, the first set of information comprises at least one of a structure of the neural network model or one or more weights of the neural network model. Additionally or alternatively, the first set of information comprises an indication of the neural network model from multiple neural network models. Additionally or alternatively, the method and apparatuses are to determine the first set of information based at least in part on an indication from a second device. Additionally or alternatively, the second device comprises the first device. Additionally or alternatively, the method and apparatuses are to determine the first set of information by training the encoder neural network model. Additionally or alternatively, to generate the encoded information is to determine at least one quantized representation of the at least the first factor vector or the second factor vector in at least one of the one or more components based on at least one of scalar quantization or vector quantization scheme. Additionally or alternatively, the method and apparatuses are to determine a number of components into which the feature vector is factorized. Additionally or alternatively, the method and apparatuses are to transmit, to the first device, a second signaling indicating the number of components. Additionally or alternatively, the method and apparatuses are to: receive, from a second device, a second signaling; and determine, based on the second signaling, a number of components into which the feature vector is factorized. Additionally or alternatively, the second device comprises the first device. Additionally or alternatively, the apparatus determines a length of the first factor vector and a length of the second factor vector in each of the one or more components. Additionally or alternatively, the method and apparatuses are to transmit, to the first device, a second signaling indicating the length of the first factor vector and the length of the second factor vector in each of the one or more components. Additionally or alternatively, the method and apparatuses are to receive, from a second device, a second signaling indicating a length of the first factor vector and a length of the second factor vector in each of the one or more components. Additionally or alternatively, the method and apparatuses are the second device comprises the first device. Additionally or alternatively, the method and apparatuses are to determine the one or more components based on an error threshold. Additionally or alternatively, the method and apparatuses are to: determine an error threshold based on a message signal received from a second device; and determine the one or more components based on the error threshold. Additionally or alternatively, the second device comprises the first device. Additionally or alternatively, the method and apparatuses are to: factorize, based on Khatri-Rao factorization, the first factor vector into one or more additional components that each include a third factor vector and a fourth factor vector; and generate the encoded information by encoding at least the third factor vector or the fourth factor vector in at least one of the components. Additionally or alternatively, the method and apparatuses are to: determine an error vector indicating an error between the at least one feature vector and a Khatri-Rao product of the first factor vector and the second factor vector; select a particular number of largest elements of the error vector; and include, in the first signaling, an indication of both the particular number of largest elements of the error vector and positions of the particular number of largest elements in the error vector. Additionally or alternatively, a number of the one or more components is greater than one and a length of the first factor vector in a first component of the one or more components is different than the length of the first factor vector in a second component of the one or more components, and the method and apparatus are to perform a factorization process to determine the first factor vector and the second factor vector in a particular component by: dividing a feature vector of the at least one feature vector into a first number of vectors each having a first length, wherein the first length is smaller than a length of the feature vector; reshaping, using the first number of vectors each having the first length, the feature vector into a matrix of a first size; computing a singular value decomposition of the matrix and determining left singular vectors of the matrix, right singular vectors of the matrix, and singular values of the matrix; computing the first factor vector in the first component as the left singular vector corresponding to a highest singular value for the particular component; computing the second factor vector in the first component as the right singular vector corresponding to the highest singular value; multiplying the first factor vector with the highest singular value or multiplying the second factor vector with the highest singular value, or multiplying the first factor vector and the second factor vector each with a square root of the highest singular value; computing an error vector by subtracting a column-wise Khatri-Rao product of the first factor vector of the first component with the second factor vector of the first component from the feature vector; computing a value of a function of the error vector to determine an error value; stopping the factorization process if the error value is less than an error threshold or a number of components have been computed; and replacing, if the error value is greater than the error threshold or if less than the number of components have been computed, the feature vector with the error vector and repeating the factorization process. Additionally or alternatively, the first factor vector has a same dimension in each of the one or more components, the second factor vector has a same dimension in each of the one or more components, and the method and apparatuses are to determine, for each component, the first factor vector and the second factor vector by: dividing a feature vector of the at least one feature vector into a first number of vectors each having a first length wherein the first length is smaller than a length of the feature vector; reshaping, using the first number of vectors each having the first length the feature vector into a matrix of a first size; computing a singular value decomposition of the matrix and determining left singular vectors of the matrix, right singular vectors of the matrix, and singular values of the matrix; computing the first factor vector in the first component as the left singular vector corresponding to a highest singular value for the component; computing the second factor vector in the first component as the right singular vector corresponding to the highest singular value; and multiplying the first factor vector in the first component with the highest singular value or multiplying the second factor vector in the first component with the highest singular value or multiplying the first factor vector and the second factor vector each, in the first component, with a square root of the highest singular value. Additionally or alternatively, a sequence comprising an encoding of the at least the first factor vector or the second factor vector in at least one of the components corresponds to precoding matrix information that is indicated in the first signaling.

Some implementations of the method and apparatuses described herein may further include to: receive, from a first device, a first signaling indicating a first set of information; input, to a decoder neural network model, input data based on at least one of the first set of information and a first set of parameters; output, by the decoder neural network model, output data generated using the input data and a second set of information used to determine the decoder neural network model for decoding the input data.

In some implementations of the method and apparatuses described herein, the first set of information comprises at least one set of components wherein each component includes an encoded first factor vector and an encoded second factor vector and wherein each set of components corresponds to a feature vector. Additionally or alternatively, the first factor vector is a first column vector, the second factor vector is a second column vector, and the feature vector is a third column vector. Additionally or alternatively, a number of components in the at least one set of components and lengths of factor vectors in each component of the at least one set of components are determined by a neural network. Additionally or alternatively, the first set of parameters includes information indicating a length of a first factor vector and a length of a second factor vector in each component of at least one set of components from which the input data is generated. Additionally or alternatively, the output data is channel state information. Additionally or alternatively, the first set of parameters includes information indicating encoding performed at the first device including at least one of a quantization codebook associated with at least one vector dequantization or demapping scheme, a type of at least one scalar quantization scheme, or a number of quantization levels for the at least one scalar quantization scheme. Additionally or alternatively, the first set of parameters includes information indicating a number of components corresponding to each feature vector. Additionally or alternatively, the method and apparatus are to determine the first set of parameters based on one or more of a predefined value or an indication received from the first device or a different device than the first device. Additionally or alternatively, the method and apparatus are to determine at least part of the first set of parameters in conjunction with training the decoder neural network model. Additionally or alternatively, the method and apparatus are to reconstruct a feature vector based on: the first set of information comprising at least one set of components with each component further including an encoded first factor vector and an encoded second factor vector; and the first set of parameters. Additionally or alternatively, the first set of information comprises at least one set of components and the method and apparatuses are to: decode the encoded first factor vector and the encoded second factor vector in each of the at least one set of components corresponding to a feature vector; determine a vector based on a Khatri-Rao product of the first factor vector and the second factor vector in each of the at least one set of components; and reconstruct the feature vector by summing the determined vectors. Additionally or alternatively, the second set of information comprises at least one of a structure of the decoder neural network model or one or more weights of the decoder neural network model. Additionally or alternatively, the first device determines the second set of information to comprise the decoder neural network model from multiple decoder neural network models. Additionally or alternatively, the first device determines the second set of information to comprise the decoder neural network model based on an indication received from the apparatus or a different device than the apparatus. Additionally or alternatively, the first device determines the second set of information in conjunction with training the neural network model.

### BRIEF DESCRIPTION OF THE DRAWINGS

FIG. 1 illustrates an example of a wireless communications system that supports feature vector compression for two-sided channel state information feedback models in wireless networks in accordance with aspects of the present disclosure.

FIG. 2 illustrates an example of a two-sided AI/ML technique that supports feature vector compression for two-sided channel state information feedback models in wireless networks in accordance with aspects of the present disclosure.

FIG. 3 illustrates an example of compressing feature vectors of a two-sided AI/ML that supports feature vector compression for two-sided channel state information feedback models in wireless networks in accordance with aspects of the present disclosure.

FIGS. 4 and 5 illustrate examples of block diagrams of devices that support feature vector compression for two-sided channel state information feedback models in wireless networks in accordance with aspects of the present disclosure.

FIGS. 6 through 12 illustrate flowcharts of methods that support feature vector compression for two-sided channel state information feedback models in wireless networks in accordance with aspects of the present disclosure.

### DETAILED DESCRIPTION

A wireless network can include multiple antennas at the transmitting device and multiple antennas at the receiving device, such as a UE having r antennas and a network entity (e.g., base station) having t antennas. Such a wireless channel between the network entity and the UE has a total of rt number of paths. In the downlink communication, where the network entity sends information to the UE, the discrete-time channel can be represented as a r×t dimensional complex-valued matrix H, with element hᵢⱼ of H denoting the complex-valued channel gain between i^{th} receive antenna and j^{th} transmit antenna, 1≤i≤r, 1≤j≤t.

The wireless channel gains, or the channel matrix H, depends on the physical propagation medium and due to the dynamic nature of the physical propagation medium, the wireless channel is a time-varying channel. Further, the channel gains depend on the frequency of operation—with a multicarrier waveform, such as orthogonal frequency division multiplexing (OFDM), the channel matrix can assume different values at different sub-carriers (e.g., frequencies) at the same instant of time. In other words, the wireless channel matrix H is stochastic in nature, varying across time, frequency and spatial dimensions. By adapting the transmission method as per the channel realization or pre-processing the information signal to be transmitted according to the current channel realization, better throughput can be achieved over the communication link while making the link more reliable.

To achieve such an adaptive transmission or to implement pre-processing at the transmitter, the CSI is transmitted to the transmitter. This amounts to the transmitter knowing the channel matrix H over the entire frequency range of operation (e.g., at every sub-carrier in the case of OFDM/multi-carrier waveforms) every time the channel changes.

The receiver estimates the channel through reference or pilot signals sent by the transmitter and transmits the acquired channel knowledge to the transmitter by sending back, or feeding back, the CSI the receiver acquired. Thus, in a downlink communication (e.g., from a network entity to a UE), the UE estimates the downlink CSI (typically, the channel matrix, or the channel covariance matrix) with the help of pilot or reference signals sent by the network entity, and sends the CSI back to the network entity. However, the CSI is an overhead for the wireless network as the CSI is not user data. Accordingly, it would be beneficial to minimize the CSI overhead sent in the form of feedback from the UE while allowing the network entity to acquire CSI of sufficient quality to enable the network entity to improve the communication over the link.

Once a receiver estimates the CSI, the device can use various techniques to compress the estimated CSI and feed back the compressed version of the CSI to the transmitter device. One technique for CSI compression for the purpose of feeding back CSI from a receiver to a transmitter is a two-sided AI/ML model for CSI compression. A two-sided AI/ML model includes two neural networks, an encoder NN and a decoder NN. The encoder NN computes a low-dimensional feature vector (e.g., a low-dimensional feature vector) of the input CSI. The decoder NN reconstructs the CSI based on the low-dimensional feature vector. By deploying the encoder NN at the receiver and the decoder NN at the transmitter, feedback of CSI by the receiver amounts to the feedback of the low-dimensional feature vector computed by the encoder at the receiver. Thus, the two-sided AI/ML model achieves CSI compression for feeding back the CSI from a receiver to a transmitter.

A lossy compression technique is described herein for compressing the feature vector computed by the encoder NN that allows the amount of CSI feedback to be further reduced while still allowing the transmitter device to acquire CSI of sufficient quality to enable the transmitter device to improve the communication over the link.

A receiver (e.g., a receiving device) receives pilot or reference signals from a transmitter (e.g., a transmitting device) on a wireless channel and generates CSI feedback for the wireless channel. The receiver uses an encoder NN to generate a feature vector based on the CSI feedback. The receiver also factorizes, based on KR factorization, the feature vector into one or more components with each component including a first factor vector and a second factor vector. The first factor vector and the second factor vector each have a smaller length (e.g., fewer elements) than the feature vector. The receiver transmits the first factor vector and the second factor vector to the transmitter, and the transmitter can reconstruct the feature vector from the first factor vector and the second factor vector, and reconstruct the CSI feedback from the feature vector.

Using the techniques discussed herein, the amount of signaling overhead used to convey the feature vector (from one wireless device to the other) is reduced by compressing the feature vector. The feature vector is compressed by factoring, using Khatri-Rao Factorization (KRF), the feature vector into at least two factor vectors each having a smaller length than the feature vector. By factoring the feature vector, CSI signaling overhead is reduced due to the first factor vector and the second factor vector together being smaller than the feature vector. Although using the factor vectors may result in loss of some quality or accuracy in the CSI feedback, the CSI feedback can still be reconstructed well enough and having sufficient quality to allow the transmitting device (e.g., the network entity for downlink) to enhance or improve the communication over the wireless link between the two devices.

Aspects of the present disclosure are described in the context of a wireless communications system. Aspects of the present disclosure are further illustrated and described with reference to device diagrams and flowcharts.

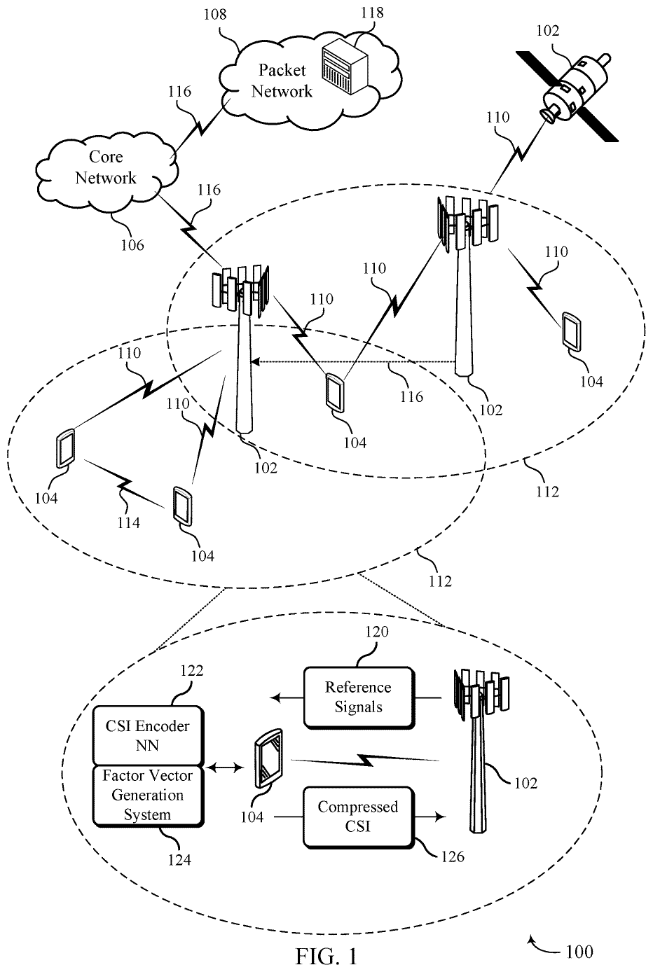

FIG. 1 illustrates an example of a wireless communications system 100 that supports feature vector compression for two-sided channel state information feedback models in wireless networks in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), a user plane function (UPF)), or a location management function (LMF), which is a control plane entity that manages location services. In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHZ), FR4a or FR4-1 (52.6 GHz-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In one or more implementations, a wireless network includes multiple antennas at the transmitting device and multiple antennas at the receiving device. For example, consider a UE 104 having r antennas and a network entity 102 (e.g., base station such as a gNB), equipped with t antennas. Such a wireless channel between the network entity 102 and the UE 104 has a total of rt number of paths. In the downlink communication, where the network entity 102 sends information to the UE 104, the discrete-time channel can be represented as a r×t dimensional complex-valued matrix H, with element hᵢⱼ of H denoting the complex-valued channel gain between i^{th} receive antenna and j^{th} transmit antenna, 1≤i≤r, 1≤j≤t.

As can be understood, the wireless channel gains, or the channel matrix H depends on the physical propagation medium and due to the dynamic nature of the physical propagation medium, the wireless channel is a time-varying channel. Further, the channel gains depend on the frequency of operation—with a multicarrier waveform, such as OFDM, the channel matrix can assume different values at different sub-carriers (e.g., frequencies) at the same instant of time. In other words, the wireless channel matrix H is stochastic in nature, varying across time, frequency and spatial dimensions. By adapting the transmission method as per the channel realization and/or pre-processing the information signal to be transmitted according to the current channel realization, better throughput can be achieved over the communication link while making the link more reliable.

To achieve such an adaptive transmission or to implement pre-processing at the transmitter, the channel state information (CSI) is used at the transmitter. This amounts to the transmitter knowing the channel matrix H over the entire frequency range of operation (e.g., at every sub-carrier in the case of OFDM or multi-carrier waveforms) every time the channel changes.

The receiver can estimate the channel matrix H through reference or pilot signals sent by the transmitter. A method for the transmitter to acquire the channel knowledge is through the receiver sending back, or feeding back, the CSI it acquired. Thus, in a downlink communication (from a network entity 102 to a UE 104), the network entity 102 transmits reference signals 120 that the UE 104 receives. The UE 104 estimates the downlink CSI (e.g., generates a channel matrix H or channel covariance matrix) and a CSI encoder NN 122 encodes the CSI into a feature vector. Generating the feature vector can also be viewed as a first level of compression of the CSI. A factor vector generation system 124 factorizes the feature vector, resulting in one or more components where each component includes a first factor vector and a second factor vector. Each of the first factor vector and the second factor vector has fewer elements than the feature vector. Factorizing the feature vector can also be viewed as a second level of compression of the CSI. The UE 104 then transmits the one or more components to the network entity 102 as the compressed CSI 126. Similarly, in the uplink communication from the UE 104 to the network entity 102, the network entity 102 estimates the CSI based on uplink reference or pilot signals from the UE 104, encodes the CSI into a feature vector and factorizes the feature vector into one or more components, and feeds back the one or more components to the UE 104 as the CSI.

Communication between devices discussed herein, such as between UEs 104 and network entities 102, is performed using any of a variety of different signaling. For example, such signaling can be any of various messages, requests, or responses, such as triggering messages, configuration messages, and so forth. By way of another example, such signaling can be any of various signaling mediums or protocols over which messages are conveyed, such as any combination of radio resource control (RRC), downlink control information (DCI), uplink control information (UCI), sidelink control information (SCI), medium access control element (MAC-CE), sidelink positioning protocol (SLPP), PC5 radio resource control (PC5-RRC) and so forth.

AI/ML based CSI compression, in particular, a two-sided AI/ML model for CSI compression including compressing the feature vectors of the two-sided AI/ML model is discussed herein.

AI/ML, including the paradigm of deep learning and deep neural networks (DNN), can be used to find efficient solutions for the problems that arise in transmission and reception of information over wireless channels. The techniques discussed herein provide efficient methods for making CSI available at the transmitter based on AI/ML, reducing the amount of data that is transmitted from the receiver to the transmitter when providing CSI feedback to the transmitter.

An autoencoder (AE) may be used for CSI compression. An AE is a DNN that can be used for dimensionality reduction. An AE includes two parts, an encoder E_{ω}, which is a DNN with learnable or trainable parameters denoted by ω, and a decoder D_{ψ}, which is another DNN with ψ as its set of trainable or learnable parameters. The encoder learns a representation of the input signal or data (in other words, encodes the input signal or data) such that the key attributes of the input signal or data are captured as one or more low-dimensional feature vectors. The decoder validates the encoding and helps the encoder to refine its encoding by trying to regenerate the input signal or data from the feature vectors generated by the encoder. Thus, the encoder and the decoder are trained and developed together such that the signal or data at the input to the encoder is reconstructed, as faithfully as possible, at the output of the decoder. Thus, the two neural networks, or the two models E_{ω} and D_{ψ} together constitute an autoencoder.

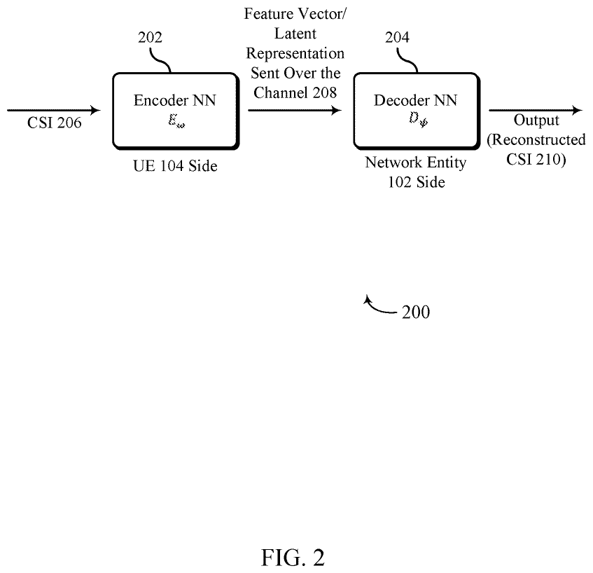

FIG. 2 illustrates an example of a two-sided AI/ML technique 200 that supports feature vector compression for two-sided channel state information feedback models in wireless networks in accordance with aspects of the present disclosure. The example technique 200 is a two-side AI/ML model technique for CSI compression and feedback for downlink communication, from a network entity 102 to a UE 104. Although discussed with reference to downlink communication, the example technique 200 can similarly be used for other communications, such as uplink communication (e.g., where the encoder NN is included at the network entity side and the decoder NN is included at the UE side), sidelink communication, and so forth.

An AE including an encoder NN 202 and a decoder NN 204 is trained to efficiently encode and decode the channel matrices. For example, the training data set includes a large number of wireless channel matrices (e.g., collected from the field or generated through simulations) and the AE is trained such that the encoder NN 202 generates a lower-dimensional feature vector (also referred to as a latent representation) of the input channel matrix and the decoder NN 204 reconstructs the channel matrix from the feature vector generated by the encoder NN 202. After training, the encoder NN 202, E_{ψ}, is deployed at the UE 104 and the decoder NN 204, D_{ψ}, is deployed at the network entity 102. The UE 104 estimates the channel matrix (e.g., CSI 206) using the reference or pilot signals received from the network entity 102, encodes the channel matrix using the encoder NN 202, and transmits the encoded output (feature vectors or a latent representation of the channel matrix) computed by the encoder NN 202 over the wireless channel 208 towards the network entity 102. The network entity 102, using the decoder NN 204 D_{ψ}, decodes or reconstructs the channel matrix, illustrated as reconstructed CSI 210, from the feature vectors received from the UE 104. As the AE achieves a high amount of dimensionality reduction, a good amount of compression of CSI information transmitted over the channel may be achieved using this technique. It should be noted that the compressed CSI data at the output of the encoder NN 202 is features or feature vectors computed by the encoder NN 202.

In some situations it is enough for the transmitter to know the left-singular vectors of H or the eigenvectors of H*H, in place of H. The AE based CSI compression technique, discussed above, can also be used for the feedback of the singular vectors or eigenvectors of the channel matrix. In such a case, the AE is trained to efficiently represent or compress a matrix comprising the singular vectors or eigenvectors.

For the feedback of CSI, the receiver node (e.g., the UE 104 in the case of downlink communication and the network entity 102 in the case of uplink communication) feeds back the feature vector (the latent representation) determined by the encoder NN 202 to the transmitter node (the network entity 102 in the case of downlink communication and the UE 104 in the case of uplink communication). Using the techniques discussed herein, the encoder NN 202 compresses the feature vector, which further reduces the amount of feedback from the receiver to the transmitter, while still allowing the decoder NN 204 at the transmitter to generate a reconstructed CSI 210 that is of reasonable quality compared to no feature compression.

In the case of a two-sided AI/ML model for CSI compression, the feature vector computed by the encoder NN at the receiver is transmitted over the wireless channel to the decoder NN located at the transmitter. Thus, the number of information bits or information symbols sent over the channel to convey the feature vector from the encoder NN at one wireless device to the decoder NN at the other wireless device is, essentially, the CSI signaling overhead, or CSI feedback overhead in CSI compression using a two-sided AI/ML model.

One technique to reduce this signaling overhead is to train the two-sided AI/ML model such that the feature vector determined or computed by the encoder NN has a short length. Developing an AI/ML model to have a shorter feature vector length may be valuable as deep learning methods are capable of extracting the key features from every input data sample (e.g., CSI in this case). However, developing an AI/ML model to have a short feature vector length results in a higher number of neural layers in the encoder NN as well as in the decoder NN, requiring correspondingly high amounts of storage and computational requirements. Additionally, training such a highly deep network may consume a large amount of training time. Also, the time required for re-training or updating such a model may also be high if the model comprises a higher number of neural layers.

Another technique to reduce this signaling overhead is to quantize the feature vector such that the number of bits used to transmit the feature vector is reduced. Quantization could be a simple scalar quantization scheme or a more complex, but effective, vector quantization scheme. Quantization could be a combination of both scalar and vector quantization schemes. Quantization can be considered as a form of lossy compression where the loss in information increases with the amount of compression.

Using the techniques discussed herein, the amount of signaling overhead used to convey the feature vector (from one wireless device to the other) is reduced by compressing the feature vector by factoring the feature vector into at least two factor vectors each having a smaller length than the original feature vector through KRF, as discussed in more detail below. The technique can be summarized as follows. A feature vector is factorized into multiple lower dimensional vectors, referred to KR factor vectors, using KRF. The smaller length KR factor vectors are fed back from a receiver device (e.g., the UE 104 in the case of downlink) to a transmitter device (e.g., the network entity 102 in the case of downlink). At the transmitter device, the full-length feature vector is reconstructed by generating a KR product of the KR factor vectors. The AI/ML model AI/ML is trained such that the decoder NN at the transmitter device reconstructs the CSI based on the reconstructed feature vector, which was reconstructed from its smaller length KR factor vectors.

The techniques discussed herein can be considered as a compression in the numerical domain. It should be noted that the proposed method can complement existing methods. Accordingly, the techniques discussed herein can bring additional compression when used jointly with other techniques.

For example, consider that the two-sided AI/ML model is a highly sophisticated or advanced model that is capable of producing a short length feature vectors for each input data sample (e.g., input CSI). The techniques discussed herein can still be used to further compress the feature vector, by factorizing the feature vector produced by the AI/ML model into two vectors of shorter length through KRF and feeding back the two lower dimensional vectors in place of the full-length feature vector.

By way of another example, the techniques discussed herein can be used along with the methods for quantization of the feature vectors as follows. Instead of quantizing the full-length feature vector, first the full-length feature vector is factorized into two shorter length factor vectors and those two shorter factor vectors are quantized following conventional methods of quantization.

The techniques discussed herein are based on KRF, also referred to as Khatri-Rao product Approximation (KRPA), of vectors. In general, the feature vector of an AI/ML model is a real-valued vector of length n≥1. The algorithms described herein also work for complex-valued vectors. Thus, though the vectors are denoted as though they contain all real-valued elements, it should be noted that the described algorithms are applicable even when the vectors contain complex-valued elements.

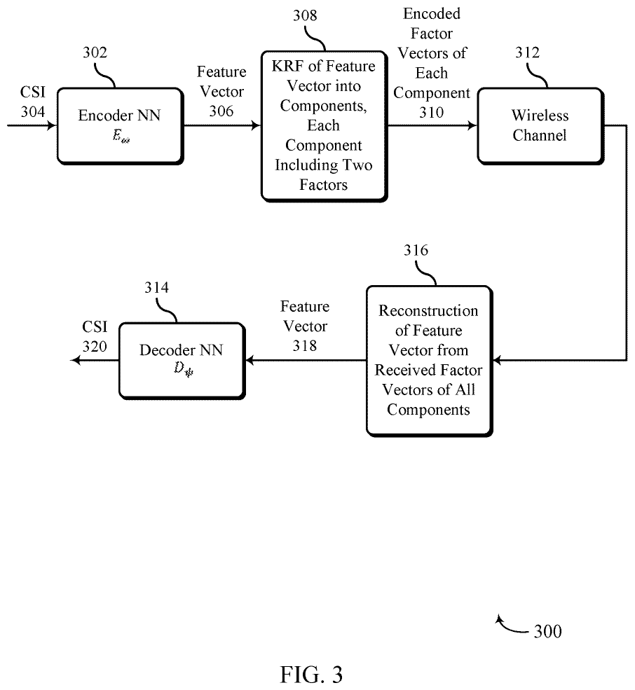

FIG. 3 illustrates an example 300 of compressing feature vectors of a two-sided AI/ML that supports feature vector compression for two-sided channel state information feedback models in wireless networks in accordance with aspects of the present disclosure. The example 300 is a schematic of compressing the feature vectors in a two-sided AI/ML model for CSI compression and feedback.

In the example 300, an encoder NN 302 receives CSI 304 and generates a feature vector 306 from the CSI 304. At 308, the feature vector 306 is factorized using KRF into one or more components, each of the one or more components including two lower dimensional factor vectors (or factors) referred to KR factor vectors. The KR factor vectors from the one or more components are encoded and the encoded KR factor vectors 310 are fed from the receiver device (e.g., that includes the encoder NN 302) over the wireless channel 312 to a transmitter device (e.g., that includes the decoder NN 314). At the transmitter device, at 316 the full-length feature vector 318 is reconstructed by generating a KR product of the KR factor vectors. The decoder NN 314 generates, based on the feature vector 318, a CSI 320. The CSI 320 is a reconstructed version of the CSI 304.

The following notation is used herein. For a length-t column vector a∈ [symbol] , or a row vector a∈ [symbol] , aᵢ denotes the i^{th} element of the vector. For a matrix Z∈ [symbol] , Zᵢⱼ, Z_{i,1:t}, Z_{1:r,j} denote (i, j)^{th} element, i^{th} row, j^{th} column of matrix Z, respectively. A block of matrix Z consisting of elements in row i to i′ and column j to j′ and is denoted by Z_{i:i′,j:j′}. Superscript T and superscript * denotes conjugate transpose (also known as Hermitian transpose) of a vector or a matrix. Thus, for a vector a, a^{T} denotes transpose of a, and a* denotes conjugate transpose (or, Hermitian) of a and the same holds true for a matrix A. Note that, for a real-valued vector a, conjugate transpose is equivalent to transpose, i.e., a*=a^{T} and similarly, for a real-valued matrix A, A*=A^{T}. Finally, ∥a∥_{F} denotes Frobenius norm of vector a.

Although discussed herein with reference to column vectors, it should be noted that the techniques discussed herein can be applied analogously using row vectors.

Consider vectors a and b having real-valued elements with dimensions n₁×1 and n₂×1, respectively, which implies that a∈ [symbol] , b∈ [symbol] in formal mathematical notation. The column-wise KR product, also referred to as the column-wise Kronecker product or column-wise matrix direct product, of a and b, denoted by a⋄b, is defined as

$$c = a ◇b = {[ {a}_{1} {b}^{T} {a}_{2} {b}^{T} {⋯a}_{{n}_{1}} {b}^{T} ]}^{T} ∈ \text{?} \qquad ( 1 )$$

The column-wise KR product indicates that, through column-wise KR product, two smaller-length vectors construct a larger length vector. In equation (1), the vectors a and b are referred to as the KR factor vectors (or, simply, factors), of vector c.

The KRF finds (smaller length) KR factor vectors for a given (larger length) vector. In the following, the KRF (also referred to as KR approximation) of a given vector is discussed.

With respect to single-term KRF, consider a vector c∈ [symbol] where n=n₁×n₂. The single-term KRF determines the vectors a∈ [symbol] , b∈ [symbol] such that a⋄b is a close approximation of c in the least-squares sense.

As the vector c is being approximated with a single KR product term (comprising vectors a and b), the approximation is referred to as single-term KRF to distinguish it from other cases, discussed in more detail below, where the KR product involves multiple terms, with each term involving two smaller-length vectors.

Furthermore, it should be noted that expressing a vector as a KR product of two vectors may also be referred to KRPA, as the KR product of the KR factor vectors a and b may not exactly be the same as original vector c.

When vectors a and b are found, vector c can be reconstructed (possibly, with a tolerable difference between the reconstructed vector and the original vector) through column-wise KR product of a and b. Thus, when elements of c are to be communicated or transmitted over a communication channel, only elements of a and b can be communicated. Accordingly, only n₁+n₂ elements or real-numbers can be transmitted to represent n₁n₂ elements or real-numbers, where n=n₁n₂. This results in considerable savings in the communication resources and the amount of overhead. This is also the case when elements of c are stored in memory-instead of storing the elements of c, the elements of a and b can be stored. It should be noted that the word “term” is used synonymously with the word “component” in this disclosure.

A procedure or algorithm for single-term least squares KRF or single-term KRPA is as follows. In the following, vec refers to a vectorization operator that converts any given matrix into a vector by stacking its columns. For a r×t dimensional matrix Z,

$$v e c ( Z ) = {[ {z}_{11} {z}_{21} ⋯ {z}_{r 1} {z}_{12} {z}_{22} ⋯ {z}_{r 2} ⋯ {z}_{1 t} {z}_{2 t} ⋯ {z}_{r t} ]}^{T}$$

where the superscript T denotes transpose operation.

The functioning of the vec operator when applied to vectors is as follows. When vec is applied to a column vector, vec does not change the column vector in any manner. Thus, vec is an identity operation when applied to a column vector. When vec is applied over a row vector, it effectively transposes the row vector into a column vector.

For single-term least-squares KRF or KRPA of a vector c∈ [symbol] , the input to the algorithm is Vector c∈ [symbol] , n₁, n₂, where n₁, n₂ are integers and n=n₁n₂, and the output of the algorithm is KR factor vectors a∈ [symbol] , b∈ [symbol] .

In one or more implementations the algorithm for single-term least squares KRF or single-term KRPA is described below with acts (A), (B), (C), and (D), and is also referred to as Algorithm 1.
(A). Write or visualize c as a vector consisting of n₁ blocks, where the dimension of each block is n₂×1. Let

$${c}_{i}^{b} , 1 \leq i \leq {n}_{1} ,$$

is the i^{th} block of vector c, where,

$${c}_{i}^{b} = {c}_{( i - 1 ) {n}_{2} + 1 : {in}_{2}}$$

Thus, each block

$${c}_{i}^{b} , 1 \leq i \leq {n}_{1} ,$$

in vector c is a vector of size n₂×1 with its elements given by the above equation.
(B). Obtain matrix \tilde{C}∈ [symbol] , as shown below:

$$\tilde{c} = [ \begin{matrix}v e {c ( {c}_{1}^{b} )}^{T} \\ ⋮ \\ v e {c ( {c}_{{n}_{1}}^{b} )}^{T}\end{matrix} ] ∈ \text{?}$$

(C). Perform singular value decomposition (SVD) on the matrix \tilde{C}

$$SVD ( \tilde{C} ) = U Σ {V}^{*}$$

where U is a size n₁×n₁ unitary matrix and V is a size n₂×n₂ unitary matrix comprising of left and right singular vectors, respectively, of \tilde{C} and Σ is a diagonal matrix of size n₁×n₂ where Σᵢᵢ=σᵢ, 1≤i≤R, are the singular values of \tilde{C}, where σ₁≥σ₂≥ . . . ≥σ_{R} and R=min(n₁, n₂).
(D). Compute KR factor vectors a, b as

$$a = \sqrt{{σ}_{1}} {U}_{: , 1} and b = \sqrt{{σ}_{1}} {V}_{: , 1} \qquad ( 2 )$$

It should be noted that the Algorithm 1, described above, works even when vector c consists of complex-valued elements.

It should also be noted that, in some examples, the factorization of c into factor vectors a and b may be performed using the Kronecker product decomposition (KPD) algorithm. The KPD algorithm decomposes a given real-valued matrix into two matrices of lower dimensions. When the KPD algorithm is applied for decomposing a real-valued vector (instead of a matrix), then the resulting algorithm is similar to the KRF Algorithm 1 described above. Accordingly, when the vector c is a real-valued vector, factorization of c can also be performed through the KPD algorithm by applying it to the given real-valued column vector rather than to a matrix. Additionally or alternatively, a given complex-valued vector can be factorized using the KPD algorithm by first converting the complex-valued vector into a real-valued vector through a one-to-one mapping and then applying the KPD algorithm.

With respect to multi-term KRF, a vector c can be expressed as a summation of multiple terms, where each term consists of a KR product of two vectors, which is referred to multi-term KR factorization of vector c. Formally, multi-term KRF of a vector c can be expressed as

$$c = {\sum }_{k = 1}^{K} {a}^{( k )} ♢ {b}^{( k )} \qquad ( 3 )$$

where a^{(k)} ∈ [symbol] , b^{(k)} ∈ [symbol] for 1≤k≤K. It should be noted that the dimensions of KR factor vectors a^{(k)} and b^{(k)} remain the same in all the terms. For example, c=a⁽¹⁾⋄b⁽¹⁾+a⁽²⁾⋄b⁽²⁾, where a⁽¹⁾ and a⁽²⁾ have same dimensions and b⁽¹⁾ and b⁽²⁾ have same dimensions.

Following the same procedure as discussed above regarding single-term least squares KRF or KRPA of a vector (e.g., Algorithm 1), the multi-term KRF can be computed by making

$${a}^{( k )} = \sqrt{{σ}_{k}} {U}_{: , k} and {b}^{( k )} = \sqrt{{σ}_{k}} {V}_{: , k} , 1 \leq k \leq K , K = R = min ( {n}_{1} , {n}_{2} ) \qquad ( 4 )$$

It should be noted that the value of R (which is equal to min(n₁, n₂)) depends on the chosen configuration of the KRF, or, equivalently, dimensions of the KR factor vectors n₁, n₂. The single-term KRF, or the single-term KRPA of c, is the result when k=1 in equation (3) and equation (4).

For multi-term KRF or KRPA of c∈ [symbol] , the input to the algorithm is vector c∈ [symbol] , n₁, n₂, where n₁, n₂ are integers and n=n₁n₂, and K≤min(n₁, n₂), and the output of the algorithm is KR factor vectors a^{(k)} ∈ [symbol] , b^{(k)} ∈ [symbol] , k=1, . . . , K. K refers to the number of terms or components being generated from KRF.

In one or more implementations the algorithm for multi-term KRF is described below, and is also referred to as Algorithm 2.

For each value k, perform acts (A), (B), and (C) of Algorithm 1 discussed above.

Then, compute KR factor matrices a^{(k)}, b^{(k)} as

$${a}^{( k )} = \sqrt{{σ}_{k}} {U}_{: , k} and {b}^{( k )} = \sqrt{{σ}_{k}} {V}_{: , k} , 1 \leq k \leq K$$

Accordingly, expressing a vector c as a multi-term KRF results in a better approximation of c, but at the expense of a lower amount of compression. Note that Algorithm 2, described above, works for any complex-valued vector as well, e.g., Algorithm 2 works even when vector c contains complex-valued elements.

In some examples, the factorization of c into factor vectors a^{(k)} and b^{(k)} may be performed using the KPD algorithm. If the algorithm for multi-term KPD of real-valued matrices (where a given matrix is decomposed into multiple terms and each term contains two lower-dimensional matrices) and use the algorithm for multi-term decomposition of a real-valued vector, then the resulting algorithm would be the similar as Algorithm 2 described above. Accordingly, the factorization of a real-valued vector c into multiple terms with each term comprising two factor vectors can also be performed through the multi-term KPD algorithm. Additionally or alternatively, a given complex-valued vector can be factorized using the KPD algorithm by first converting the complex-valued vector into a real-valued vector through a one-to-one mapping and then applying the KPD algorithm.

With respect to multi-term KRF with flexible dimensions for KR factor matrices, a multi-term KRF where the dimensions of the KR factor matrices in each term need not be the same,

$$e . g . , {a}^{( k )} ∈ {ℝ}^{{r}_{1}^{( k )} \times {t}_{1}^{( k )}} , {b}^{( k )} ∈ {ℝ}^{{r}_{2}^{( k )} \times {t}_{2}^{( k )}} , k = 1 , … , K ,$$

and, importantly,

$${r}_{1}^{( k )}$$

need not be equal to

$${r}_{1}^{( k ′ )}$$

when k≠k′ and

$${t}_{1}^{( k )}$$

need not be equal to

$${t}_{1}^{( k ′ )}$$

when k≠k′ is considered. Thus, dimensions of a^{(k)} can be different from the dimensions of a^{(k′)} and dimensions of b^{(k)} can be different from the dimensions of b^{(k′)} for k≠k′. Formally, such a multi-term KRF of a vector c∈ [symbol] can be expressed as follows:

$$c = {\sum }_{k = 1}^{K} {a}^{( k )} ♢ {b}^{( k )} \qquad ( 5 )$$

where

$${a}^{( k )} ∈ {ℝ}^{{n}_{1}^{( k )} \times 1} , {b}^{( k )} ∈ {ℝ}^{{n}_{2}^{( k )} \times 1} and {n}_{1}^{( k )} {n}_{2}^{( k )} = n ,$$

for 1≤k≤K. For example, c=a⁽¹⁾⋄b⁽¹⁾+a⁽²⁾⋄b⁽²⁾, where a⁽¹⁾ and a⁽²⁾ have different dimensions and b⁽¹⁾ and b⁽²⁾ have different dimensions.

It should be noted that there is an additional flexibility in such a multi-term KRF compared to the multi-term KRF discussed above: the KR factor matrices can have different dimensions in each term. Such a KRF can be useful sometimes depending on the vector c for which the KRF is computed.

In one or more implementations the algorithm for such a flexible multi-term KRF is described below, and is also referred to as Algorithm 3. Algorithm 3 is an iterative algorithm using Algorithm 1.

For multi-term KRF of vector c∈ [symbol] with flexible dimensions for KR factor matrices, the input is vector

$$c ∈ {ℝ}^{n \times 1} , {n}_{1}^{( k )} , {n}_{2}^{( k )} , k = 1 , … , K ,$$

where

$${n}_{1}^{( k )} , {n}_{2}^{( k )}$$

are integers such that

$${n}_{1}^{( k )} {n}_{2}^{( k )} = n for 1 \leq k \leq K ,$$

and the output is KR factor matrices

$${a}^{( k )} ∈ {ℝ}^{{n}_{1}^{( k )} \times 1} , {b}^{( k )} ∈ {ℝ}^{{n}_{2}^{( k )} \times 1} , k = 1 , … , K .$$

The algorithm or procedure is:

```
for k = 1 → K
  $Using Algorithm 1 with inputs c ∈ \text{?} , {n}_{1}^{( k )} , {n}_{2}^{( k )} , perform single - term KRF of vector c$
  $Algorithm 1 returns KR factor matrices a ∈ \text{?} and b ∈ \text{?}$
  Set a^{(k)} = a and b^{(k)} = b
  Set c = c − a^{(k)}⋄b^{(k)}
end
```

It should be noted that Algorithm 3, described above, is applicable even when vector c consists of complex-valued elements.

In one or more implementations, Algorithm 3 stops if an error value is less than an error threshold or K number of components have been computed. This error threshold can be decided by the device including the encoder NN, can be received from another device (e.g., the device including the decoder NN), and so forth. The error value can be computed in various manners. In one or more implementations, the vector c is factorized into two factor vectors a⁽¹⁾ and b⁽¹⁾. Then a check is made as to whether it is acceptable to have just these two factor vectors by computing e=c−a⁽¹⁾⋄b⁽¹⁾. Thus, e is the error vector when just the two factor vectors are factorized. A function of the error vector is computed (e.g., ∥e∥_{F}, the Frobenius norm of error vector e, is computed) to obtain the error value. If the error value is below the error threshold, then factorization is stopped. Otherwise, the next set of factors a⁽²⁾ and b⁽²⁾ are computed.

It should also be noted that in some examples, the factorization of c into factor vectors a^{(k)} and b^{(k)} may be performed using the KPD algorithm. When the multi-term KPD with flexible dimensions is applied for real-valued matrices (where we decompose a given matrix into multiple terms and each term contains two lower-dimensional matrices) and use it for multi-term decomposition of a real-valued vector, then the resulting algorithm is similar to Algorithm 3 described above. Additionally or alternatively, a given complex-valued vector can be factorized using the KPD algorithm by first converting the complex-valued vector into a real-valued vector through a one-to-one mapping and then applying the KPD algorithm.

The techniques discussed herein can be employed in practice in a variety of different manners, examples of which are discussed below. Use of multi-level compression of feature vectors is also discussed below.

In one or more implementations, the techniques discussed herein are implemented using an off-the-shelf pre-trained two-sided AI/ML model. For example, consider a trained two-sided AI/ML model that has been trained considering no compression of the feature vectors at the output of the encoder NN. The techniques discussed herein for compressing the feature vectors using column-wise KR product, or column-wise matrix direct product, can be readily employed on such a two-sided AI/ML models. Each of the feature vectors computed by the encoder NN is factorized into one or more terms using KRF, where each term consists of two factor vectors. For example, let xᵢ∈ [symbol] be the feature vector corresponding to the i^{th} input data sample. For the purpose of illustration, consider that the length-n feature vector xᵢ has been factorized, using KRF, into two terms with the first term consisting of factor vectors aᵢ⁽¹⁾∈ [symbol] and bᵢ⁽¹⁾∈ [symbol] and the second term consisting of factor vectors aᵢ⁽²⁾∈ [symbol] and bᵢ⁽²⁾∈ [symbol] , where n₁n₂=n. Now, instead of sending the original feature vector xᵢ to the decoder NN, the factor vectors aᵢ⁽¹⁾, b₁⁽¹⁾, aᵢ⁽²⁾, b₁⁽²⁾ are sent to the decoder NN, resulting in transmitting 2(n₁+n₂) real-valued elements in place of n₁n₂ real-valued elements.

At the input of the decoder NN, original feature vector, to be precise, an approximation of the original feature vector, denoted by [symbol] is constructed through column-wise matrix direct product of the factor vectors as given by [symbol] =aᵢ⁽¹⁾⋄b₁⁽¹⁾+aᵢ⁽²⁾+b₁(2). Note that [symbol] may not be exactly same as xᵢ (the difference depends on the chosen configuration of the KRF, e.g., on n₁, n₂ and the number of terms K). This results in the input feature vector to the decoder NN being slightly different from the desired feature vector. The decoder NN, being an AI/ML model, may be able to tolerate noisy or corrupted feature vectors (e.g., with the amount of noise or corruption under certain limits) and may be able to produce the desired output even when supplied with an approximated version of the feature vector. By employing a two-sided model that is more robust to noisy data and noisy feature vectors, and by choosing the KRF configuration appropriately, acceptable performance from the two-sided model can be achieved with the feature vector compression techniques discussed herein.

In one or more implementations, how good the performance of the decoder NN is when supplied with an approximated version of the original feature vector depends on various factors, such as the particular neural network being considered, including how robust the network is and how the network is trained.

It should be noted that, as shown by Algorithms 2 and 3 discussed above, there are a number of possible values for the number of terms K in the factorization and the dimensions of the factor vectors and they can be chosen depending on the constraints on the amount of feedback and the difference between the original feature vector and the reconstructed feature vector from the factor vectors.

Additionally or alternatively, the techniques discussed herein are implemented using an AI/ML model developed by considering feature vector compression during the training phase itself, which typically provides better performance compared to using an off-the-shelf pre-trained two-sided AI/ML model. For example, during training, for each input data sample, the encoder NN computes a set of feature vectors (the set containing one or more feature vectors). Let xᵢ∈ [symbol] be the feature vector corresponding to the i^{th} input data sample, denoted by dᵢ. For the purpose of illustration, consider that the length-n feature vector xᵢ has been factorized, using KRF, into two terms with the first term consisting of factor vectors aᵢ⁽¹⁾∈ [symbol] and b₁⁽¹⁾∈ [symbol] and the second term consisting of factor vectors aᵢ⁽²⁾∈ [symbol] and b₁⁽²⁾∈ [symbol] , where n₁n₂=n.

At the input of the decoder NN, a length-n vector, denoted by [symbol] is constructed through column-wise matrix direct product of the factor vectors as given by

$$\hat{{x}_{i}} = {a}_{i}^{( 1 )} ♢ {b}_{i}^{( 1 )} + {a}_{i}^{( 2 )} ♢ {b}_{i}^{( 2 )} .$$

It should be noted that [symbol] may not be exactly same as xᵢ (the difference depends on the chosen configuration of the KRF, e.g., on n₁, n₂ and the number of terms K). The labeled training sample for the decoder is ( [symbol] , dᵢ) where [symbol] is the input and dᵢ is the desired output. Without feature vector compression, the labeled training sample of the decoder would be (xᵢ, dᵢ) where xᵢ is the input and dᵢ is the desired output. With a large number of such labeled samples, the decoder NN is trained to produce the desired output when it is supplied with the reconstructed feature vectors from the factor vectors, where typically the reconstructed feature vector is an approximation of the original feature vector computed by the encoder NN. In this manner, the decoder NN is trained to work well and produce the desired output, which effectively means that a two-sided AI/ML model developed using this training would provide the desired performance.

When the feature vector is computed by the encoder NN located at one wireless device, the feature vector is factorized as discussed above. After the factorization of the feature vector, there would be K≥1 terms (also referred to as components) components), each term or component comprising two factor vectors. For example, let K=2 and the feature vector c is factorized into two components, the first component including factor vectors a⁽¹⁾, b⁽¹⁾ and the second component including two factor vectors a⁽²⁾, b⁽²⁾. These factor vectors are transmitted to the decoder NN located at another wireless device.

The factor vectors can be transmitted in any of a variety of manners. In one or more implementations, each factor vector is quantized using a vector quantizer or a scalar quantizer.

In the case of vector quantization, each factor vector is mapped to a vector or codeword in a codebook and the corresponding index of the codebook and the index of the codeword are sent to the other wireless device after converting the indices into bits and into channel symbols. The mapping, e.g., mapping of a factor vector to a vector or codeword in a codebook, is known at both the wireless devices (e.g., through communication between the devices or through prior information available at both the devices). Thus, when the other device receives the index or the codeword and the codebook, the device de-maps the received indices to obtain the corresponding vectors. This procedure of mapping the factor vectors into codebook and codewords indices may also be referred to as quantization and the reverse procedure of determining the vectors corresponding to the received indices at the other wireless node may be referred to dequantization.

In the case of scalar quantization, each element of a factor vector is quantized using a scalar quantizer. Each quantized element of the factor vector is then converted into bits and then to channel symbols and sent over the channel. At the other wireless device, the elements of the received factor vector are the ones that are scalar quantized at the first wireless node.

Once the factor vectors in all the components, e.g., a⁽¹⁾, b⁽¹⁾, a⁽²⁾, b⁽²⁾ in this example, are transmitted from the wireless device that includes the encoder NN and received at the other wireless device having the decoder NN, and input to the decoder NN is the reconstructed full-length feature vector ê, where ĉ=a⁽¹⁾⋄b⁽¹⁾+a⁽²⁾⋄b⁽²⁾.

The discussion above describes compressing a feature vector based on a column-wise KR product (also known as a column-wise matrix direct product or a column-wise KR product). For example, assume that a feature vector c of length-n has been factorized into two factor vectors a and b, having length n₁ and n₂, respectively, where n=n₁n₂. This factorization would result in a compression from n₁n₂ elements to n₁+n₂ elements, which can be called a first level of compression.

The factor vector a can further be factorized into two factor vectors d and e, having length l₁ and l₂, respectively, where l₁l₂=n₁. By transmitting or feeding back vectors d, e and b, the vector a can be reconstructed from the column-wise KR product of d and e and then vector c can be reconstructed through column-wise KR product of a and b. Compared to the first level of compression, this technique of further or a second level of factorizing or compressing vector a would reduce the feedback from n₁+n₂ elements to l₁+l₂+n₂ and, as n₁=l₁l₂, l₁+l₂+n₂≤n₁+n₂. In a similar manner, vector b can further be factorized into two vectors each having a smaller length than n₂, resulting in more compression and further reduction in the feedback.

The multi-level compression, as outlined above, can increase the amount of compression, but it would also typically increase ∥c−ĉ∥_{F}, where ê is the reconstructed vector from the factor vectors. Thus, the compressing the feature vectors and the extending it to multi-level compression allows a trade-off between the amount of compression and desired accuracy of the reconstructed feature vector.

In one or more implementations, the error between the original vector and the vector reconstructed from the factor vectors, ∥c−ĉ∥_{F}, depends on the chosen configuration (e.g., the number of terms and the lengths of the factor vectors in each term) of the KRF. The error can be lowered by one or both of considering a higher number of terms or by adjusting the lengths of the factor vectors. However, reducing the error results in lower compression and increased signaling overhead in transmitting the factor vectors.

In one or more implementations, one or both of the number of terms and the lengths of the factors in each term are determined based on an error threshold. For example, the number of terms is selected so that the error between the original vector and the vector reconstructed from the factor vectors, ∥c−ĉ∥_{F}, is less than an error threshold. This error threshold can be decided by the device including the encoder NN, can be received from another device (e.g., the device including the decoder NN), and so forth.

In one or more implementations, the error is reduced without increasing the number of terms in the factorization. For example, consider single-term KRF of a given feature vector c into two factor vectors a and b, and transmitting a and b towards the other wireless device, where the decoder NN is located. Compute the error vector c−ĉ, where ĉ=a⋄b, and, for convenience, let c−ĉ=cₑ. Find L≥1 largest elements of the error vector cₑ and transmit the corresponding L element values of the error vector cₑ, along with the indices of those elements (i.e., information on their location in cₑ) to the other wireless node. Thus, in addition to the two factor vectors a and b, these L largest elements of the error vector are also transmitted to the other wireless device.

At the other wireless node, while reconstructing the full-length feature vector at the input of the decoder, a⋄b=c is computed. Then to the vector ĉ, the L elements of cₑ are added to appropriate elements of ĉ as per the indices of the received L elements of cₑ.

In one or more implementations, when n, the length of the feature vector, is a prime number, there are not any integer factors for n and the feature vector cannot be factorized or compressed into factor vectors having length shorter than n. Similarly, when the value of n is an odd number, there are very few integer factors of n, compared to the case when n is an even number. In such cases, the length of the feature vector can be extended by one unit by padding the feature vector at the end (or at the beginning) with a zero. Thus, when the original length of the feature vector is a prime number or an odd-valued number, then, after padding the feature vector with a zero-valued element at the end (or at the beginning), the length of the feature vector becomes an even number and there are multiple options for choosing the lengths of the factor vectors. When the full-length feature vector is reconstructed at the input of the decoder NN at the other wireless device, the last element (or the first element) of the reconstructed feature vector is omitted or deleted before giving it to the decoder NN.

In one or more implementations, the compressed feature vector may be associated with a Precoding Matrix Indicator (PMI) value.

Additionally or alternatively, a set of compressed feature vectors are derived, where each compressed feature vector corresponds to a distinct layer of the PMI.

Additionally or alternatively, the set of compressed feature vectors corresponds to AI-based CSI feedback transmitted from one device (e.g., the UE) to another device (e.g., the network entity).

Additionally or alternatively, the set of compressed feature vectors are fed back as part of a CSI report comprising CSI, beam information, or a combination thereof.

In contrast to using quantization (either scalar or vector quantization) for compressing the feature vector, the techniques discussed herein compress the feature vector in the numerical domain.

The techniques discussed herein can be used as a stand-alone method or jointly with other techniques for achieving CSI compression. No matter how short the length of the feature vector produced by the encoder NN of a two-sided AI/ML model is, the techniques discussed herein can further shorten the length of the feature vector to be sent to the decoder NN in the two-sided AI/ML model. The compressed feature vector can further be quantized similar to how an uncompressed or full-length feature vector is quantized, thereby not losing the benefits of compression through quantization.

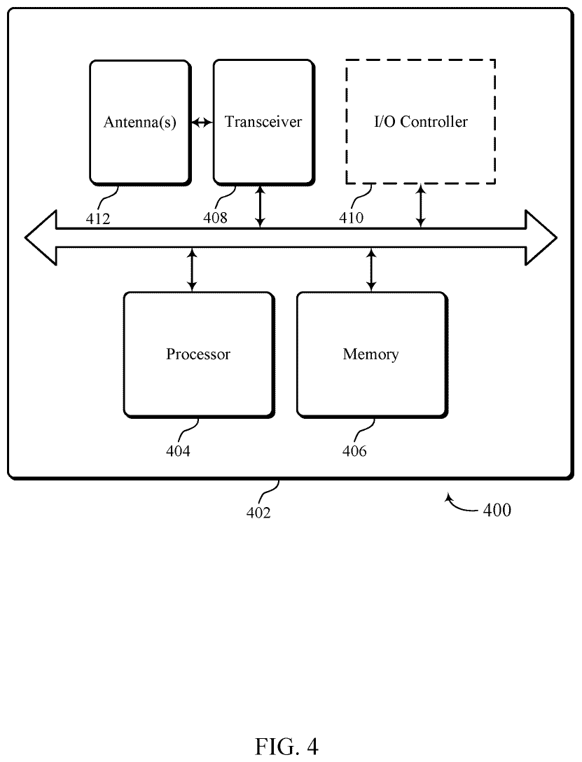

FIG. 4 illustrates an example of a block diagram 400 of a device 402 that supports feature vector compression for two-sided channel state information feedback models in wireless networks in accordance with aspects of the present disclosure. The device 402 may be an example of a device that includes an encoder NN, such as a UE 104 as described herein. The device 402 may also be referred to as an apparatus. The device 402 may support wireless communication with one or more network entities 102, UEs 104, or any combination thereof. The device 402 may include components for bi-directional communications including components for transmitting and receiving communications, such as a processor 404, a memory 406, a transceiver 408, and an I/O controller 410. These components may be in electronic communication or otherwise coupled (e.g., operatively, communicatively, functionally, electronically, electrically) via one or more interfaces (e.g., buses).

The processor 404, the memory 406, the transceiver 408, or various combinations thereof or various components thereof may be examples of means for performing various aspects of the present disclosure as described herein. For example, the processor 404, the memory 406, the transceiver 408, or various combinations or components thereof may support a method for performing one or more of the operations described herein.

In some implementations, the processor 404, the memory 406, the transceiver 408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 404 and the memory 406 coupled with the processor 404 may be configured to perform one or more of the functions described herein (e.g., executing, by the processor 404, instructions stored in the memory 406).

For example, the processor 404 may support wireless communication at the device 402 in accordance with examples as disclosed herein. Processor 404 may be configured as or otherwise support to: determine at least one feature vector of input data; factorize, based on Khatri-Rao factorization, the at least one feature vector into one or more components where each component comprises a first factor vector and a second factor vector, and each of the first factor vector and the second factor vector has fewer elements than the feature vector; generate encoded information by encoding at least the first factor vector or the second factor vector in at least one of the components; transmit, to a first device, a first signaling indicating the encoded information.

Additionally or alternatively, the processor 404 may be configured to or otherwise support: where the first factor vector is a first column vector, the second factor vector is a second column vector, and the feature vector is a column vector; where the input data is channel state information; where processor is further configured to cause the apparatus to: receive, from the first device, at least one reference signal; and generate the channel state information based on the received at least one reference signal; where the channel state information comprises a characterization of a channel matrix or a channel covariance matrix; where the at least one feature vector of the input data is based at least in part on a first set of information of an encoder neural network model; where the first set of information comprises at least one of a structure of the neural network model or one or more weights of the neural network model; where the first set of information comprises an indication of the neural network model from multiple neural network models; where the processor is further configured to cause the apparatus to determine the first set of information based at least in part on an indication from a second device; where the second device comprises the first device; where the processor is further configured to cause the apparatus to determine the first set of information by training the encoder neural network model; where to generate the encoded information is to determine at least one quantized representation of the at least the first factor vector or the second factor vector in at least one of the one or more components based on at least one of scalar quantization or vector quantization scheme; where the processor is further configured to cause the apparatus to determine a number of components into which the feature vector is factorized; where the processor is further configured to cause the apparatus to transmit, to the first device, a second signaling indicating the number of components; where the processor is further configured to cause the apparatus to: receive, from a second device, a second signaling; and determine, based on the second signaling, a number of components into which the feature vector is factorized; where the second device comprises the first device; where the apparatus determines a length of the first factor vector and a length of the second factor vector in each of the one or more components; where the processor is further configured to cause the apparatus to transmit, to the first device, a second signaling indicating the length of the first factor vector and the length of the second factor vector in each of the one or more components; where the processor is further configured to cause the apparatus to receive, from a second device, a second signaling indicating a length of the first factor vector and a length of the second factor vector in each of the one or more components; where the second device comprises the first device; where the processor is further configured to cause the apparatus to determine the one or more components based on an error threshold; where the processor is further configured to cause the apparatus to: determine an error threshold based on a message signal received from a second device; and determine the one or more components based on the error threshold; where the second device comprises the first device; where the processor is further configured to cause the apparatus to: factorize, based on Khatri-Rao factorization, the first factor vector into one or more additional components that each include a third factor vector and a fourth factor vector; and generate the encoded information by encoding at least the third factor vector or the fourth factor vector in at least one of the components; where the processor is further configured to cause the apparatus to: determine an error vector indicating an error between the at least one feature vector and a Khatri-Rao product of the first factor vector and the second factor vector; select a particular number of largest elements of the error vector; and include, in the first signaling, an indication of both the particular number of largest elements of the error vector and positions of the particular number of largest elements in the error vector; where a number of the one or more components is greater than one and a length of the first factor vector in a first component of the one or more components is different than the length of the first factor vector in a second component of the one or more components, and where the processor is further configured to cause the apparatus to perform a factorization process to determine the first factor vector and the second factor vector in a particular component by: dividing a feature vector of the at least one feature vector into a first number of vectors each having a first length, where the first length is smaller than a length of the feature vector; reshaping, using the first number of vectors each having the first length, the feature vector into a matrix of a first size; computing a singular value decomposition of the matrix and determining left singular vectors of the matrix, right singular vectors of the matrix, and singular values of the matrix; computing the first factor vector in the first component as the left singular vector corresponding to a highest singular value for the particular component; computing the second factor vector in the first component as the right singular vector corresponding to the highest singular value; multiplying the first factor vector with the highest singular value or multiplying the second factor vector with the highest singular value, or multiplying the first factor vector and the second factor vector each with a square root of the highest singular value; computing an error vector by subtracting a column-wise Khatri-Rao product of the first factor vector of the first component with the second factor vector of the first component from the feature vector; computing a value of a function of the error vector to determine an error value; stopping the factorization process if the error value is less than an error threshold or a number of components have been computed; and replacing, if the error value is greater than the error threshold or if less than the number of components have been computed, the feature vector with the error vector and repeating the factorization process; where the first factor vector has a same dimension in each of the one or more components, the second factor vector has a same dimension in each of the one or more components, and the processor is further configured to cause the apparatus to determine, for each component, the first factor vector and the second factor vector by: dividing a feature vector of the at least one feature vector into a first number of vectors each having a first length where the first length is smaller than a length of the feature vector; reshaping, using the first number of vectors each having the first length the feature vector into a matrix of a first size; computing a singular value decomposition of the matrix and determining left singular vectors of the matrix, right singular vectors of the matrix, and singular values of the matrix; computing the first factor vector in the first component as the left singular vector corresponding to a highest singular value for the component; computing the second factor vector in the first component as the right singular vector corresponding to the highest singular value; and multiplying the first factor vector in the first component with the highest singular value or multiplying the second factor vector in the first component with the highest singular value or multiplying the first factor vector and the second factor vector each, in the first component, with a square root of the highest singular value; where a sequence including an encoding of the at least the first factor vector or the second factor vector in at least one of the components corresponds to precoding matrix information that is indicated in the first signaling.

For example, the processor 404 may support wireless communication at the device 402 in accordance with examples as disclosed herein. Processor 404 may be configured as or otherwise support a means for determining at least one feature vector of input data; factorizing, based on Khatri-Rao factorization, the at least one feature vector into one or more components where each component comprises a first factor vector and a second factor vector, and each of the first factor vector and the second factor vector has fewer elements than the feature vector; generating encoded information by encoding at least the first factor vector or the second factor vector in at least one of the components; and transmitting, to a first device, a first signaling indicating the encoded information.

Additionally or alternatively, the processor 404 may be configured to or otherwise support: where the first factor vector is a first column vector, the second factor vector is a second column vector, and the feature vector is a column vector; where the input data is channel state information; further including: receive, from the first device, at least one reference signal; and generate the channel state information based on the received at least one reference signal; where the channel state information comprises a characterization of a channel matrix or a channel covariance matrix; where the at least one feature vector of the input data is based at least in part on a first set of information of an encoder neural network model; where the first set of information comprises at least one of a structure of the neural network model or one or more weights of the neural network model; where the first set of information comprises an indication of the neural network model from multiple neural network models; determining the first set of information based at least in part on an indication from a second device; where the second device comprises the first device; further including determining the first set of information by training the encoder neural network model; where generating the encoded information comprises determining at least one quantized representation of the at least the first factor vector or the second factor vector in at least one of the one or more components based on at least one of scalar quantization or vector quantization scheme; further including determining a number of components into which the feature vector is factorized; further including transmitting, to the first device, a second signaling indicating the number of components; further including: receiving, from a second device, a second signaling; and determining, based on the second signaling, a number of components into which the feature vector is factorized; where the second device comprises the first device; further including determining a length of the first factor vector and a length of the second factor vector in each of the one or more components; further including transmitting, to the first device, a second signaling indicating the length of the first factor vector and the length of the second factor vector in each of the one or more components; further including receiving, from a second device, a second signaling indicating a length of the first factor vector and a length of the second factor vector in each of the one or more components; where the second device comprises the first device; further including determining the one or more components based on an error threshold; further including: determining an error threshold based on a message signal received from a second device; and determining the one or more components based on the error threshold; where the second device comprises the first device; further including: factorizing, based on Khatri-Rao factorization, the first factor vector into one or more additional components that each include a third factor vector and a fourth factor vector; and generating the encoded information by encoding at least the third factor vector or the fourth factor vector in at least one of the components; further including: determining an error vector indicating an error between the at least one feature vector and a Khatri-Rao product of the first factor vector and the second factor vector; selecting a particular number of largest elements of the error vector; and including, in the first signaling, an indication of both the particular number of largest elements of the error vector and positions of the particular number of largest elements in the error vector; where a number of the one or more components is greater than one and a length of the first factor vector in a first component of the one or more components is different than the length of the first factor vector in a second component of the one or more components, the method further including performing a factorization process to determine the first factor vector and the second factor vector in a particular component by: dividing a feature vector of the at least one feature vector into a first number of vectors each having a first length, where the first length is smaller than a length of the feature vector; reshaping, using the first number of vectors each having the first length, the feature vector into a matrix of a first size; computing a singular value decomposition of the matrix and determining left singular vectors of the matrix, right singular vectors of the matrix, and singular values of the matrix; computing the first factor vector in the first component as the left singular vector corresponding to a highest singular value for the particular component; computing the second factor vector in the first component as the right singular vector corresponding to the highest singular value; multiplying the first factor vector with the highest singular value or multiplying the second factor vector with the highest singular value, or multiplying the first factor vector and the second factor vector each with a square root of the highest singular value; computing an error vector by subtracting a column-wise Khatri-Rao product of the first factor vector of the first component with the second factor vector of the first component from the feature vector; computing a value of a function of the error vector to determine an error value; stopping the factorization process if the error value is less than an error threshold or a number of components have been computed; and replacing, if the error value is greater than the error threshold or if less than the number of components have been computed, the feature vector with the error vector and repeating the factorization process; where the first factor vector has a same dimension in each of the one or more components, the second factor vector has a same dimension in each of the one or more components, the method further including determining, for each component, the first factor vector and the second factor vector by: dividing a feature vector of the at least one feature vector into a first number of vectors each having a first length where the first length is smaller than a length of the feature vector; reshaping, using the first number of vectors each having the first length the feature vector into a matrix of a first size; computing a singular value decomposition of the matrix and determining left singular vectors of the matrix, right singular vectors of the matrix, and singular values of the matrix; computing the first factor vector in the first component as the left singular vector corresponding to a highest singular value for the component; computing the second factor vector in the first component as the right singular vector corresponding to the highest singular value; and multiplying the first factor vector in the first component with the highest singular value or multiplying the second factor vector in the first component with the highest singular value or multiplying the first factor vector and the second factor vector each, in the first component, with a square root of the highest singular value; where a sequence including an encoding of the at least the first factor vector or the second factor vector in at least one of the components corresponds to precoding matrix information that is indicated in the first signaling.

The processor 404 of the device 402, such as a UE 104, may support wireless communication in accordance with examples as disclosed herein. The processor 404 may include at least one controller coupled with at least one memory, and is configured to or operable to cause the processor to determine at least one feature vector of input data; factorize, based on Khatri-Rao factorization, the at least one feature vector into one or more components wherein each component comprises a first factor vector and a second factor vector, and each of the first factor vector and the second factor vector has fewer elements than the feature vector; generate encoded information by encoding at least the first factor vector or the second factor vector in at least one of the components; transmit, to a first device, a first signaling indicating the encoded information.

The processor 404 of the device 402, such as a UE 104, may support wireless communication in accordance with examples as disclosed herein. The processor 404 may include at least one controller coupled with at least one memory, and is configured to or operable to cause the processor to receive, from a first device, a first signaling indicating a first set of information; input, to a decoder neural network model, input data based on at least one of the first set of information and a first set of parameters; output, by the decoder neural network model, output data generated using the input data and a second set of information used to determine the decoder neural network model for decoding the input data.

The processor 404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 404 may be configured to operate a memory array using a memory controller. In some other implementations, a memory controller may be integrated into the processor 404. The processor 404 may be configured to execute computer-readable instructions stored in a memory (e.g., the memory 406) to cause the device 402 to perform various functions of the present disclosure.

The memory 406 may include random access memory (RAM) and read-only memory (ROM). The memory 406 may store computer-readable, computer-executable code including instructions that, when executed by the processor 404 cause the device 402 to perform various functions described herein. The code may be stored in a non-transitory computer-readable medium such as system memory or another type of memory. In some implementations, the code may not be directly executable by the processor 404 but may cause a computer (e.g., when compiled and executed) to perform functions described herein. In some implementations, the memory 406 may include, among other things, a basic I/O system (BIOS) which may control basic hardware or software operation such as the interaction with peripheral components or devices.

The I/O controller 410 may manage input and output signals for the device 402. The I/O controller 410 may also manage peripherals not integrated into the device 402. In some implementations, the I/O controller 410 may represent a physical connection or port to an external peripheral. In some implementations, the I/O controller 410 may utilize an operating system such as iOS®, ANDROID®, MS-DOS®, MS-WINDOWS®, OS/2®, UNIX®, LINUX®, or another known operating system. In some implementations, the I/O controller 410 may be implemented as part of a processor, such as the processor 404. In some implementations, a user may interact with the device 402 via the I/O controller 410 or via hardware components controlled by the I/O controller 410.

In some implementations, the device 402 may include a single antenna 412. However, in some other implementations, the device 402 may have more than one antenna 412 (i.e., multiple antennas), including multiple antenna panels or antenna arrays, which may be capable of concurrently transmitting or receiving multiple wireless transmissions. The transceiver 408 may communicate bi-directionally, via the one or more antennas 412, wired, or wireless links as described herein. For example, the transceiver 408 may represent a wireless transceiver and may communicate bi-directionally with another wireless transceiver. The transceiver 408 may also include a modem to modulate the packets, to provide the modulated packets to one or more antennas 412 for transmission, and to demodulate packets received from the one or more antennas 412.

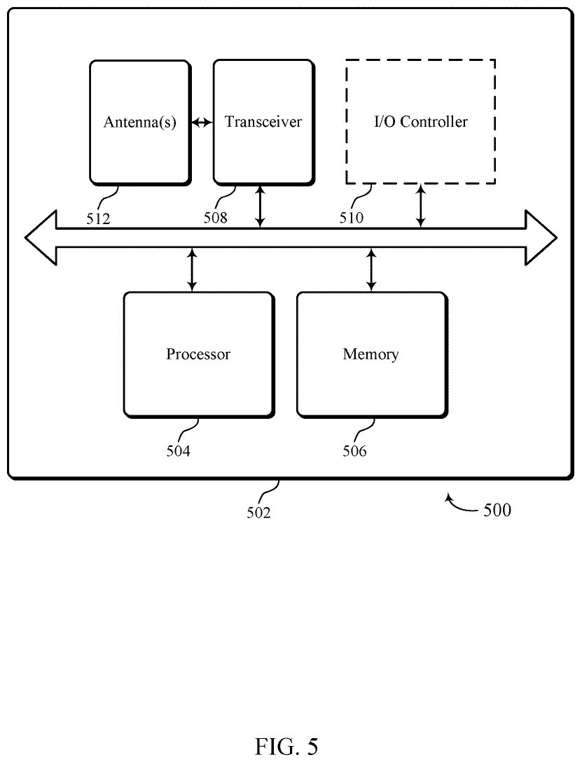

FIG. 5 illustrates an example of a block diagram 500 of a device 502 that supports feature vector compression for two-sided channel state information feedback models in wireless networks in accordance with aspects of the present disclosure. The device 502 may be an example of a device that includes a decoder NN, such as a network entity 102 as described herein. The device 502 may also be referred to as an apparatus. The device 502 may support wireless communication with one or more network entities 102, UEs 104, or any combination thereof. The device 502 may include components for bi-directional communications including components for transmitting and receiving communications, such as a processor 504, a memory 506, a transceiver 508, and an I/O controller 510. These components may be in electronic communication or otherwise coupled (e.g., operatively, communicatively, functionally, electronically, electrically) via one or more interfaces (e.g., buses).

The processor 504, the memory 506, the transceiver 508, or various combinations thereof or various components thereof may be examples of means for performing various aspects of the present disclosure as described herein. For example, the processor 504, the memory 506, the transceiver 508, or various combinations or components thereof may support a method for performing one or more of the operations described herein.

In some implementations, the processor 504, the memory 506, the transceiver 508, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 504 and the memory 506 coupled with the processor 504 may be configured to perform one or more of the functions described herein (e.g., executing, by the processor 504, instructions stored in the memory 506).

For example, the processor 504 may support wireless communication at the device 502 in accordance with examples as disclosed herein. Processor 504 may be configured as or otherwise support to: receive, from a first device, a first signaling indicating a first set of information; input, to a decoder neural network model, input data based on at least one of the first set of information and a first set of parameters; output, by the decoder neural network model, output data generated using the input data and a second set of information used to determine the decoder neural network model for decoding the input data.

Additionally or alternatively, the processor 504 may be configured to or otherwise support: where the first set of information comprises at least one set of components where each component includes an encoded first factor vector and an encoded second factor vector and where each set of components corresponds to a feature vector; where the first factor vector is a first column vector, the second factor vector is a second column vector, and the feature vector is a third column vector; where a number of components in the at least one set of components and lengths of factor vectors in each component of the at least one set of components are determined by a neural network; where the first set of parameters includes information indicating a length of a first factor vector and a length of a second factor vector in each component of at least one set of components from which the input data is generated; where the output data is channel state information; where the first set of parameters includes information indicating encoding performed at the first device including at least one of a quantization codebook associated with at least one vector dequantization or demapping scheme, a type of at least one scalar quantization scheme, or a number of quantization levels for the at least one scalar quantization scheme; where the first set of parameters includes information indicating a number of components corresponding to each feature vector; where the processor is further configured to cause the apparatus to determine the first set of parameters based on one or more of a predefined value or an indication received from the first device or a different device than the first device; where the processor is further configured to cause the apparatus to determine at least part of the first set of parameters in conjunction with training the decoder neural network model; where the processor is further configured to cause the apparatus to reconstruct a feature vector based on: the first set of information including at least one set of components with each component further including an encoded first factor vector and an encoded second factor vector; and the first set of parameters; where the first set of information comprises at least one set of components and the processor is further configured to cause the apparatus to: decode the encoded first factor vector and the encoded second factor vector in each of the at least one set of components corresponding to a feature vector; determine a vector based on a Khatri-Rao product of the first factor vector and the second factor vector in each of the at least one set of components; and reconstruct the feature vector by summing the determined vectors; where the second set of information comprises at least one of a structure of the decoder neural network model or one or more weights of the decoder neural network model; where the first device determines the second set of information to comprise the decoder neural network model from multiple decoder neural network models; where the first device determines the second set of information to comprise the decoder neural network model based on an indication received from the apparatus or a different device than the apparatus; where the first device determines the second set of information in conjunction with training the neural network model.

For example, the processor 504 may support wireless communication at the device 502 in accordance with examples as disclosed herein. Processor 504 may be configured as or otherwise support a means for receiving, from a first device, a first signaling indicating a first set of information; inputting, to a decoder neural network model, input data based on at least one of the first set of information and a first set of parameters; and outputting, by the decoder neural network model, output data generated using the input data and a second set of information used to determine the decoder neural network model for decoding the input data.

Additionally or alternatively, the processor 504 may be configured to or otherwise support: where the first set of information comprises at least one set of components where each component includes an encoded first factor vector and an encoded second factor vector and where each set of components corresponds to a feature vector; where the first factor vector is a first column vector, the second factor vector is a second column vector, and the feature vector is a third column vector; where a number of components in the at least one set of components and lengths of factor vectors in each component of the at least one set of components are determined by a neural network; where the first set of parameters includes information indicating a length of a first factor vector and a length of a second factor vector in each component of at least one set of components from which the input data is generated; where the output data is channel state information; where the first set of parameters includes information indicating encoding performed at the first device including at least one of a quantization codebook associated with at least one vector dequantization or demapping scheme, a type of at least one scalar quantization scheme, or a number of quantization levels for the at least one scalar quantization scheme; where the first set of parameters includes information indicating a number of components corresponding to each feature vector; further including determining the first set of parameters based on one or more of a predefined value or an indication received from the first device or a different device than the first device; further including determining at least part of the first set of parameters in conjunction with training the decoder neural network model; further including reconstructing a feature vector based on: the first set of information including at least one set of components with each component further including an encoded first factor vector and an encoded second factor vector; and the first set of parameters; where the first set of information comprises at least one set of components and the method further including: decoding the encoded first factor vector and the encoded second factor vector in each of the at least one set of components corresponding to a feature vector; determining a vector based on a Khatri-Rao product of the first factor vector and the second factor vector in each of the at least one set of components; and reconstructing the feature vector by summing the determined vectors; where the second set of information comprises at least one of a structure of the decoder neural network model or one or more weights of the decoder neural network model; where the first device determines the second set of information to comprise the decoder neural network model from multiple decoder neural network models; where the first device determines the second set of information to comprise the decoder neural network model based on an indication received from an apparatus that implements the method or a different device than the apparatus that implements the method; where the first device determines the second set of information in conjunction with training the neural network model.

The processor 504 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 504 may be configured to operate a memory array using a memory controller. In some other implementations, a memory controller may be integrated into the processor 504. The processor 504 may be configured to execute computer-readable instructions stored in a memory (e.g., the memory 506) to cause the device 502 to perform various functions of the present disclosure.

The memory 506 may include random access memory (RAM) and read-only memory (ROM). The memory 506 may store computer-readable, computer-executable code including instructions that, when executed by the processor 504 cause the device 502 to perform various functions described herein. The code may be stored in a non-transitory computer-readable medium such as system memory or another type of memory. In some implementations, the code may not be directly executable by the processor 504 but may cause a computer (e.g., when compiled and executed) to perform functions described herein. In some implementations, the memory 506 may include, among other things, a basic I/O system (BIOS) which may control basic hardware or software operation such as the interaction with peripheral components or devices.

The I/O controller 510 may manage input and output signals for the device 502. The I/O controller 510 may also manage peripherals not integrated into the device 502. In some implementations, the I/O controller 510 may represent a physical connection or port to an external peripheral. In some implementations, the I/O controller 510 may utilize an operating system such as iOS®, ANDROID®, MS-DOS®, MS-WINDOWS®, OS/2®, UNIX®, LINUX®, or another known operating system. In some implementations, the I/O controller 510 may be implemented as part of a processor, such as the processor 504. In some implementations, a user may interact with the device 502 via the I/O controller 510 or via hardware components controlled by the I/O controller 510.

In some implementations, the device 502 may include a single antenna 512. However, in some other implementations, the device 502 may have more than one antenna 512 (i.e., multiple antennas), including multiple antenna panels or antenna arrays, which may be capable of concurrently transmitting or receiving multiple wireless transmissions. The transceiver 508 may communicate bi-directionally, via the one or more antennas 512, wired, or wireless links as described herein. For example, the transceiver 508 may represent a wireless transceiver and may communicate bi-directionally with another wireless transceiver. The transceiver 508 may also include a modem to modulate the packets, to provide the modulated packets to one or more antennas 512 for transmission, and to demodulate packets received from the one or more antennas 512.

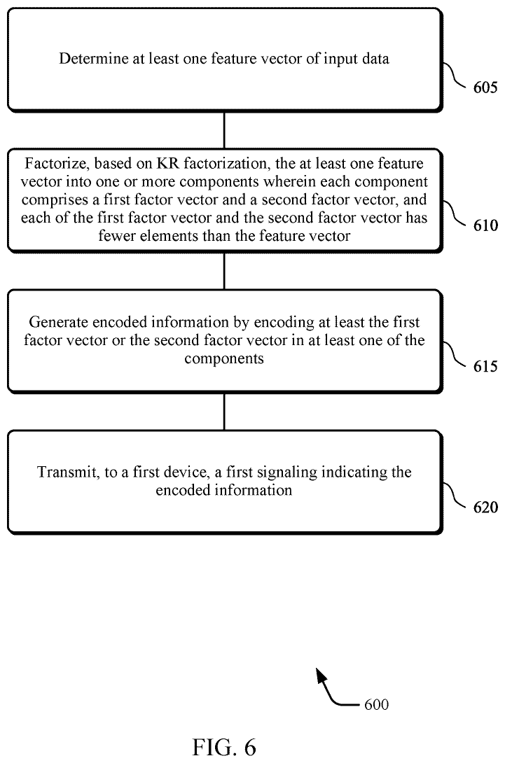

FIG. 6 illustrates a flowchart of a method 600 that supports feature vector compression for two-sided channel state information feedback models in wireless networks in accordance with aspects of the present disclosure. The operations of the method 600 may be implemented by a device or its components as described herein. For example, the operations of the method 600 may be performed by a device including an encoder NN, such as a UE 104 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 605, the method may include determining at least one feature vector of input data. The operations of 605 may be performed in accordance with examples as described herein. In some implementations, aspects of the operations of 605 may be performed by a device as described with reference to FIG. 1.

At 610, the method may include factorizing, based on KR factorization, the at least one feature vector into one or more components wherein each component comprises a first factor vector and a second factor vector, and each of the first factor vector and the second factor vector has fewer elements than the feature vector. The operations of 610 may be performed in accordance with examples as described herein. In some implementations, aspects of the operations of 610 may be performed by a device as described with reference to FIG. 1.

At 615, the method may include generating encoded information by encoding at least the first factor vector or the second factor vector in at least one of the components. The operations of 615 may be performed in accordance with examples as described herein. In some implementations, aspects of the operations of 615 may be performed by a device as described with reference to FIG. 1.

At 620, the method may include transmitting, to a first device, a first signaling indicating the encoded information. The operations of 620 may be performed in accordance with examples as described herein. In some implementations, aspects of the operations of 620 may be performed by a device as described with reference to FIG. 1.

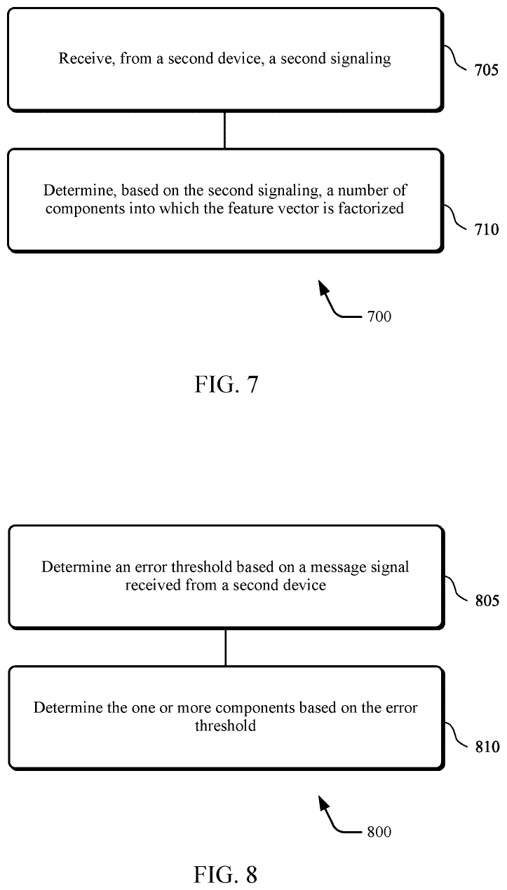

FIG. 7 illustrates a flowchart of a method 700 that supports feature vector compression for two-sided channel state information feedback models in wireless networks in accordance with aspects of the present disclosure. The operations of the method 700 may be implemented by a device or its components as described herein. For example, the operations of the method 700 may be performed by a device including an encoder NN, such as a UE 104 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 705, the method may include receiving, from a second device, a second signaling. The operations of 705 may be performed in accordance with examples as described herein. In some implementations, aspects of the operations of 705 may be performed by a device as described with reference to FIG. 1.

At 710, the method may include determining, based on the second signaling, a number of components into which the feature vector is factorized. The operations of 710 may be performed in accordance with examples as described herein. In some implementations, aspects of the operations of 710 may be performed by a device as described with reference to FIG. 1.

FIG. 8 illustrates a flowchart of a method 800 that supports feature vector compression for two-sided channel state information feedback models in wireless networks in accordance with aspects of the present disclosure. The operations of the method 800 may be implemented by a device or its components as described herein. For example, the operations of the method 800 may be performed by a device including an encoder NN, such as a UE 104 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 805, the method may include determining an error threshold based on a message signal received from a second device. The operations of 805 may be performed in accordance with examples as described herein. In some implementations, aspects of the operations of 805 may be performed by a device as described with reference to FIG. 1.

At 810, the method may include determining the one or more components based on the error threshold. The operations of 810 may be performed in accordance with examples as described herein. In some implementations, aspects of the operations of 810 may be performed by a device as described with reference to FIG. 1.

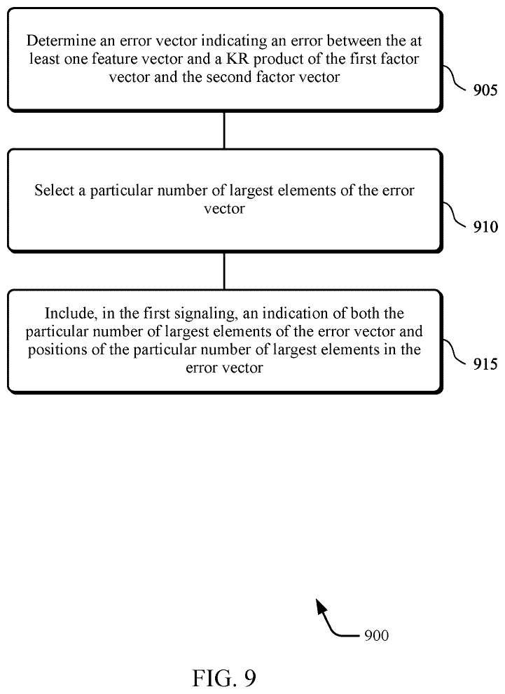

FIG. 9 illustrates a flowchart of a method 900 that supports feature vector compression for two-sided channel state information feedback models in wireless networks in accordance with aspects of the present disclosure. The operations of the method 900 may be implemented by a device or its components as described herein. For example, the operations of the method 900 may be performed by a device including an encoder NN, such as a UE 104 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 905, the method may include determining an error vector indicating an error between the at least one feature vector and a KR product of the first factor vector and the second factor vector. The operations of 905 may be performed in accordance with examples as described herein. In some implementations, aspects of the operations of 905 may be performed by a device as described with reference to FIG. 1.

At 910, the method may include selecting a particular number of largest elements of the error vector. The operations of 910 may be performed in accordance with examples as described herein. In some implementations, aspects of the operations of 910 may be performed by a device as described with reference to FIG. 1.

At 915, the method may include including, in the first signaling, an indication of both the particular number of largest elements of the error vector and positions of the particular number of largest elements in the error vector. The operations of 915 may be performed in accordance with examples as described herein. In some implementations, aspects of the operations of 915 may be performed by a device as described with reference to FIG. 1.

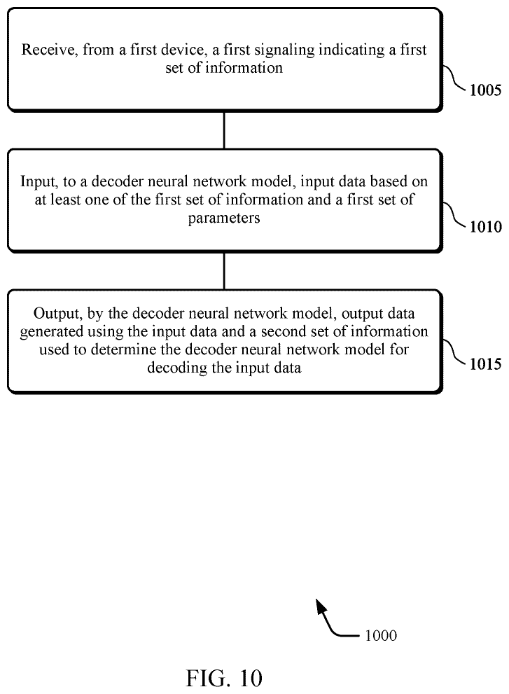

FIG. 10 illustrates a flowchart of a method 1000 that supports feature vector compression for two-sided channel state information feedback models in wireless networks in accordance with aspects of the present disclosure. The operations of the method 1000 may be implemented by a device or its components as described herein. For example, the operations of the method 1000 may be performed by a device including a decoder NN, such as network entity 102 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 1005, the method may include receiving, from a first device, a first signaling indicating a first set of information. The operations of 1005 may be performed in accordance with examples as described herein. In some implementations, aspects of the operations of 1005 may be performed by a device as described with reference to FIG. 1.

At 1010, the method may include inputting, to a decoder neural network model, input data based on at least one of the first set of information and a first set of parameters. The operations of 1010 may be performed in accordance with examples as described herein. In some implementations, aspects of the operations of 1010 may be performed by a device as described with reference to FIG. 1.

At 1015, the method may include outputting, by the decoder neural network model, output data generated using the input data and a second set of information used to determine the decoder neural network model for decoding the input data. The operations of 1015 may be performed in accordance with examples as described herein. In some implementations, aspects of the operations of 1015 may be performed by a device as described with reference to FIG. 1.

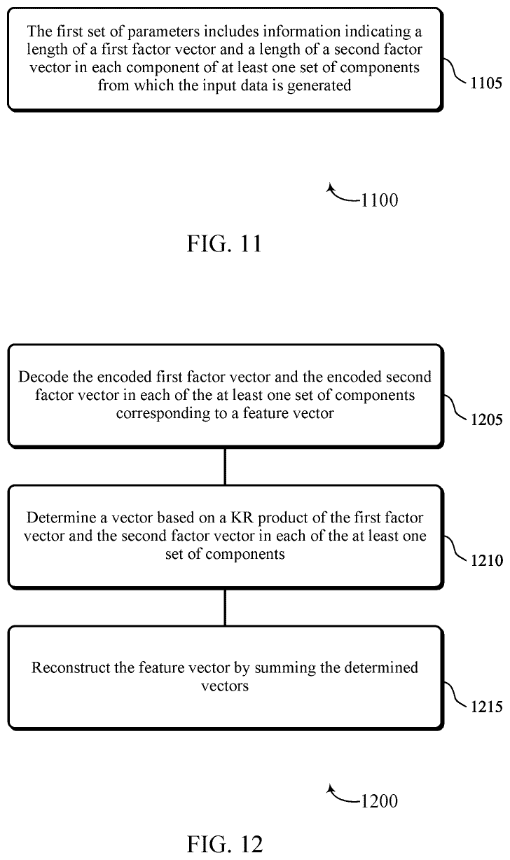

FIG. 11 illustrates a flowchart of a method 1100 that supports feature vector compression for two-sided channel state information feedback models in wireless networks in accordance with aspects of the present disclosure. The operations of the method 1100 may be implemented by a device or its components as described herein. For example, the operations of the method 1100 may be performed by a device including a decoder NN, such as network entity 102 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 1105, the method may include the first set of parameters includes information indicating a length of a first factor vector and a length of a second factor vector in each component of at least one set of components from which the input data is generated. The operations of 1105 may be performed in accordance with examples as described herein. In some implementations, aspects of the operations of 1105 may be performed by a device as described with reference to FIG. 1.

FIG. 12 illustrates a flowchart of a method 1200 that supports feature vector compression for two-sided channel state information feedback models in wireless networks in accordance with aspects of the present disclosure. The operations of the method 1200 may be implemented by a device or its components as described herein. For example, the operations of the method 1200 may be performed by a device including a decoder NN, such as network entity 102 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 1205, the method may include decoding the encoded first factor vector and the encoded second factor vector in each of the at least one set of components corresponding to a feature vector. The operations of 1205 may be performed in accordance with examples as described herein. In some implementations, aspects of the operations of 1205 may be performed by a device as described with reference to FIG. 1.

At 1210, the method may include determining a vector based on a KR product of the first factor vector and the second factor vector in each of the at least one set of components. The operations of 1210 may be performed in accordance with examples as described herein. In some implementations, aspects of the operations of 1210 may be performed by a device as described with reference to FIG. 1.

At 1215, the method may include reconstructing the feature vector by summing the determined vectors. The operations of 1215 may be performed in accordance with examples as described herein. In some implementations, aspects of the operations of 1215 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
at least one memory; and
at least one processor coupled with the at least one memory and configured to cause the apparatus to:
determine at least one feature vector of input data;
factorize, based on Khatri-Rao factorization, the at least one feature vector into one or more components wherein each component comprises a first factor vector and a second factor vector, and each of the first factor vector and the second factor vector has fewer elements than the feature vector;
generate encoded information by encoding at least the first factor vector or the second factor vector in at least one of the components;
transmit, to a first device, a first signaling indicating the encoded information.

2. The apparatus of claim 1, wherein the first factor vector is a first column vector, the second factor vector is a second column vector, and the feature vector is a column vector.

3. The apparatus of claim 1, wherein the input data is channel state information and the at least one processor is further configured to cause the apparatus to:
receive, from the first device, at least one reference signal; and
generate the channel state information based on the received at least one reference signal.

4. The apparatus of claim 1, wherein the at least one feature vector of the input data is based at least in part on a first set of information of an encoder neural network model.

5. The apparatus of claim 4, wherein the first set of information comprises at least one of a structure of the neural network model or one or more weights of the neural network model.

6. The apparatus of claim 4, wherein the first set of information comprises an indication of the neural network model from multiple neural network models.

7. The apparatus of claim 4, wherein the at least one processor is further configured to cause the apparatus to determine the first set of information based at least in part on an indication from a second device.

8. The apparatus of claim 4, wherein the at least one processor is further configured to cause the apparatus to determine the first set of information by training the encoder neural network model.

9. The apparatus of claim 1, wherein to generate the encoded information is to determine at least one quantized representation of the at least the first factor vector or the second factor vector in at least one of the one or more components based on at least one of scalar quantization or vector quantization scheme.

10. The apparatus of claim 1, wherein the at least one processor is further configured to cause the apparatus to:
determine a number of components into which the feature vector is factorized; and
transmit, to the first device, a second signaling indicating the number of components.

11. The apparatus of claim 1, wherein the at least one processor is further configured to cause the apparatus to:
receive, from the first device, a second signaling; and
determine, based on the second signaling, a number of components into which the feature vector is factorized.

12. The apparatus of claim 1, wherein the at least one processor is further configured to cause the apparatus to:
determine a length of the first factor vector and a length of the second factor vector in each of the one or more components; and
transmit, to the first device, a second signaling indicating the length of the first factor vector and the length of the second factor vector in each of the one or more components.

13. The apparatus of claim 1, wherein the at least one processor is further configured to cause the apparatus to receive, from the first device, a second signaling indicating a length of the first factor vector and a length of the second factor vector in each of the one or more components.

14. The apparatus of claim 1, wherein the at least one processor is further configured to cause the apparatus to determine the one or more components based on an error threshold.

15. The apparatus of claim 1, wherein the at least one processor is further configured to cause the apparatus to:
determine an error threshold based on a message signal received from the first device; and
determine the one or more components based on the error threshold.

16. The apparatus of claim 1, wherein the at least one processor is further configured to cause the apparatus to:
factorize, based on Khatri-Rao factorization, the first factor vector into one or more additional components that each include a third factor vector and a fourth factor vector; and
generate the encoded information by encoding at least the third factor vector or the fourth factor vector in at least one of the components.

17. The apparatus of claim 1, wherein the at least one processor is further configured to cause the apparatus to:
determine an error vector indicating an error between the at least one feature vector and a Khatri-Rao product of the first factor vector and the second factor vector;
select a particular number of largest elements of the error vector; and
include, in the first signaling, an indication of both the particular number of largest elements of the error vector and positions of the particular number of largest elements in the error vector.

18. An apparatus for wireless communication, comprising:
at least one memory; and
at least one processor coupled with the at least one memory and configured to cause the apparatus to:
receive, from a first device, a first signaling indicating a first set of information;
input, to a decoder neural network model, input data based on at least one of the first set of information and a first set of parameters;
output, by the decoder neural network model, output data generated using the input data and a second set of information used to determine the decoder neural network model for decoding the input data.

19. A method, comprising:
determining at least one feature vector of input data;
factorizing, based on Khatri-Rao factorization, the at least one feature vector into one or more components wherein each component comprises a first factor vector and a second factor vector, and each of the first factor vector and the second factor vector has fewer elements than the feature vector;
generating encoded information by encoding at least the first factor vector or the second factor vector in at least one of the components; and
transmitting, to a first device, a first signaling indicating the encoded information.

20. (canceled)

21. A method, comprising:
receiving, from a first device, a first signaling indicating a first set of information;
inputting, to a decoder neural network model, input data based on at least one of the first set of information and a first set of parameters;
outputting, by the decoder neural network model, output data generated using the input data and a second set of information used to determine the decoder neural network model for decoding the input data.
